(19) United States
(12) Patent Application Publication
(10) Pub. No.: US 2023/0305735 A1
(43) Pub. Date: Sep. 28, 2023

(54) Condition-Based Loading of a Subset of a Collision Avoidance and Detection Data Structure

(71) Applicant: Sagetech Avionics, Inc., White Salmon, WA (US)

(72) Inventors: Matthew Hamilton, White Salmon, WA (US); Tom Furey, White Salmon, WA (US)

(73) Assignee: Sagetech Avionics, Inc., White Salmon, WA (US)

(21) Appl. No.: 18/126,414

(22) Filed: Mar. 25, 2023

Related U.S. Application Data
(60) Provisional application No. 63/324,628, filed on Mar. 28, 2022.

(51) Int. Cl. G06F 3/06

(52) U.S. Cl. CPC G06F 3/0653; G06F 3/0679; G06F 3/0604

(57) ABSTRACT

An electronic device is described. This electronic device may include: a first type of memory that stores a collision avoidance and detection data structure having a predefined size, a second type of memory, and a processor. For example, the first type of memory may include a volatile memory (such as flash memory), and the second type of memory may include a non-volatile memory (such as dynamic random access memory or DRAM). During operation, the electronic device may access, in the first type of memory, a subset of the collision avoidance and detection data structure based at least in part on current conditions, where the subset is less than the predefined size, and the current conditions include a position and speed of the electronic device. Then, the electronic device may load the subset from the first type of memory to the second type of memory.

### CROSS REFERENCE TO RELATED APPLICATIONS

This application claims priority under 35 U.S.C. 119(e) to U.S. Provisional Application Ser. No. 63/324,628, “Condition-Based Loading of a Subset of a Collision Avoidance and Detection Data Structure,” filed on Mar. 28, 2022, by Matthew Hamilton, et al., the contents of which are herein incorporated by reference.

### FIELD

The described embodiments relate to a technique for loading a subset of a collision avoidance and detection data structure based at least in part on current conditions, such as a position and/or speed of an aircraft.

### BACKGROUND

The Federal Aviation Administration (FAA) in the United States mandates the use of the Traffic Alert and Collision Avoidance System (TCAS), which is a collision avoidance system and air-to-air communication technique for piloted civilian aircraft using transponder messages. Notably, the FAA regulation Title 14, CFR Part 121.356 requires TCAS for aircraft above 33,000 lb. carrying more than 10 passengers. Note that TCAS is a rule-based approach in which aircraft in flight cooperatively avoid a potential collision or threat by performing a vertical avoidance maneuver, such as climbing or descending.

TCAS is not used for helicopters or unmanned aircraft, such as drones. Currently, unless a professional waiver is granted by the FAA, the absence of a collision avoidance system for drones restricts their use to visual line of sight by the operator or to use in conjunction with a separate visual observer. Notably, Title 14 CFR Part 91.113 requires pilots to see and avoid other aircraft. If an aircraft wants to operate under Part 91 regulations, then it needs to meet this requirement. Moreover, the use of an onboard detect and avoid system can be used to meet the intent of this requirement.

In order to address these and other challenges, enhanced collision avoidance systems, such as the Airborne Collision Avoidance System (ACAS) X or another technique associated with the Radio Technical Commission for Aeronautics or RTCA (of Washington DC), are being developed. ACAS X is intended for use by a variety of different types of aircraft. For example, in addition to use with a cooperative aircraft, ACAS X may be used to detect and avoid a threat associated with a cooperative or an uncooperative aircraft (such as a drone or an aircraft that cannot communicate with you) or birds. Notably, ACAS X may use an input from a cooperative source, such as an Automatic Dependent Surveillance-Broadcast (ADS-B) message. ADS-B are Global Positioning System (GPS)-based automatic transmissions that are provided approximately 6x/s.

Moreover, in order to use ACAS, during operation aircraft are required to have a collision avoidance and detection data structure loaded into memory, such as dynamic random access memory (DRAM). Then, based on intruder-track information and own-track information, an aircraft may determine a future trajectory. When a potential collision is identified, the aircraft may access one or more look-up tables in the collision avoidance and detection data structure to determine a recommended maneuver to avoid the potential collision. Because DRAM is volatile, when not in use the collision avoidance and detection data structure is usually stored in a non-volatile memory (such as flash memory) and transferred into DRAM on boot up.

However, the collision avoidance and detection data structure is often very large. For example, the collision avoidance and detection data structure may be: 2 GB for small drones, 8 GB for mid-sized drones (such as ACAS-XU), or 16 GB for flying taxis or to support horizontal, vertical and speed-based maneuvers (such as ACAS-XR). Transferring these large amounts of data from flash memory to DRAM is typically: time consuming (e.g., 2-5 min), consumes significant power, and necessitates an increase in the size and weight of aircraft. Moreover, when there is a power outage, aircraft are required to reload the collision avoidance and detection data structure within 2 s. These requirements are challenging, especially for small aircraft (such as drones) that have limited power, as well as size and weight constraints.

### SUMMARY

An electronic device is described. This electronic device includes: a first type of memory that stores a collision avoidance and detection data structure having a predefined size, a second type of memory, and a processor. During operation, the electronic device accesses a subset of the collision avoidance and detection data structure based at least in part on current conditions, where the subset is less than the predefined size, and the current conditions include a position and speed of the electronic device. Then, the electronic device loads the subset from the first type of memory to the second type of memory.

Note that the first type of memory may include a non-volatile memory (such as flash memory). Moreover, the second type of memory may include a volatile memory (such as DRAM).

Furthermore, the subset may be loaded in less than a predefined time, such as a predefined time associated with a regulatory requirement.

Additionally, the subset may be loaded before it is needed or used. For example, the subset may be prefetched.

In some embodiments, accessing the subset may include dynamically generating the subset (and, thus, the subset may not be predefined or predetermined). Thus, the subset may be dynamically adapted as a function of time. Alternatively, the subset may be predefined or predetermined. For example, the collision avoidance and detection data structure may have been previously subdivided into different subsets having associated indexing information. Note that at least two of the subsets may, at least in part, partially overlap. Moreover, the subset or the subsets may be specified by a pretrained predictive model, such as a pretrained predictive model that was trained using a supervised-learning technique (e.g., a machine-learning technique or a neural network).

Furthermore, the current conditions may include: an altitude of the electronic device, or a heading of the electronic device. Additionally, the position may correspond to a three-dimensional (3D) track of the electronic device, and the position may be relative to a second electronic device (such as an intruder aircraft).

Another embodiment provides a computer-readable storage medium for use with the electronic device. When executed by the electronic device, this computer-readable storage medium causes the electronic device to perform at least some of the aforementioned operations.

Another embodiment provides a method, which may be performed by the electronic device. This method includes at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### DRAWINGS

FIG. 1 is a block diagram illustrating an example of an electronic device according to some embodiments of the present disclosure.

FIG. 2 is a flow diagram illustrating an example of a method for loading a subset of a collision avoidance and detection data structure that may be performed by the electronic device of FIG. 1 according to some embodiments of the present disclosure.

FIG. 3 is a block diagram illustrating an example of communication between components in the electronic device of FIG. 1 according to some embodiments of the present disclosure.

FIG. 4 is a flow diagram illustrating an example of a method for accessing a data record according to some embodiments of the present disclosure.

FIG. 5 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An electronic device is described. This electronic device may include: a first type of memory that stores a collision avoidance and detection data structure having a predefined size, a second type of memory, and a processor. For example, the first type of memory may include a non-volatile memory (such as flash memory), and the second type of memory may include a volatile memory (such as DRAM). During operation, the electronic device may access, in the first type of memory, a subset of the collision avoidance and detection data structure based at least in part on current conditions, where the subset is less than the predefined size, and the current conditions include a position and speed of the electronic device. Then, the electronic device may load the subset from the first type of memory to the second type of memory.

By loading the subset, these memory techniques may reduce the load time while ensuring regulatory compliance. Moreover, the memory techniques may reduce: power consumption, size of the electronic device or a vehicle that includes the electronic device (such as an aircraft) and/or weight of the electronic device. These capabilities may make it easier for small aircraft to comply with regulations, such as drones that have limited power, as well as size and weight constraints. Consequently, the memory techniques may provide additional design degrees of freedom and cost savings for aircraft, including aircraft that are small, lightweight and/or that have limited power.

In the discussion that follows, the electronic device may include or may be included in an aircraft, such as a manned or an unmanned aircraft. For example, the electronic device may include an aircraft, such as: an airplane, a helicopter, a glider, a drone, an airborne taxi or another type of aircraft.

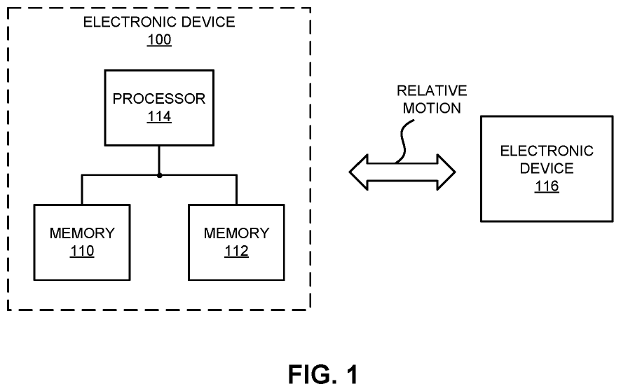

We now further describe the memory techniques. FIG. 1 presents a block diagram illustrating an example of an electronic device 100. This electronic device may include: a first type of memory 110 that stores a collision avoidance and detection data structure having a predefined size, a second type of memory 112, and a processor 114. For example, the first type of memory 110 may include a non-volatile memory (such as flash memory), and the second type of memory 112 may include a volatile memory (such as DRAM).

During operation, processor 114 may access, in the first type of memory 110, a subset of the collision avoidance and detection data structure based at least in part on current conditions, where the subset is less than the predefined size, and the current conditions include a position and speed of electronic device 100. Then, processor 114 may load the subset from the first type of memory 110 to the second type of memory 112.

Moreover, when processor 114 determines that there is a potential risk of collision with electronic device 116 (such as an aircraft or an aircraft that includes electronic device 116), processor 114 may use the subset in the second type of memory to compute a recommended avoidance maneuver. Furthermore, processor 114 may instruct electronic device 100 to perform a remedial action based at least in part on the recommended avoidance maneuver, such as changing altitude, speed and/or heading.

Note that electronic device 100 may include fewer or additional components, a different component, two or more components may be combined into a single component, or a single component may be divided into two or more components.

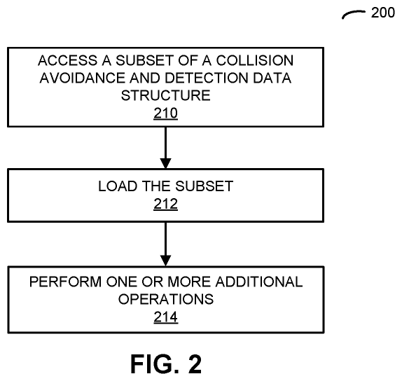

We now describe embodiments of the method. FIG. 2 presents a flow diagram illustrating an example of a method 200 for loading a subset of a collision avoidance and detection data structure that may be performed by an electronic device, such as electronic device 100 (FIG. 1). During operation, the electronic device may access, in a first type of memory, the subset (operation 210) of the collision avoidance and detection data structure based at least in part on current conditions, wherein the subset is less than a predefined size of the collision avoidance and detection data structure, and the current conditions comprise a position and speed of the electronic device. Note that the first type of memory may include a non-volatile memory (such as flash memory). Moreover, the second type of memory may include a volatile memory (such as DRAM).

Furthermore, the current conditions may include: an altitude of the electronic device, or a heading of the electronic device. Additionally, the position may correspond to a 3D track of the electronic device, and the position may be relative to a second electronic device (such as an intruder aircraft). More generally, the position may include an absolute position of the electronic device and/or a relative position of the electronic device.

Then, the electronic device may load the (operation 212) subset from the first type of memory to a second type of memory. Furthermore, the subset may be loaded in less than a predefined time, such as a predefined time associated with a regulatory requirement. Additionally, the subset may be loaded before it is needed or used. For example, the subset may be prefetched.

In some embodiments, the electronic device may perform one or more optional additional operations (operation 214). For example, accessing the subset (operation 210) may include dynamically generating the subset (and, thus, the subset may not be predefined or predetermined). In some embodiments, the subset may be dynamically adapted as a function of time.

Alternatively, the subset may be predefined or predetermined. For example, the collision avoidance and detection data structure may have been previously subdivided into different subsets having associated indexing information. Note that at least two of the subsets may, at least in part, partially overlap.

Moreover, the subset or the subsets may be specified by a pretrained predictive model, such as a pretrained predictive model that was trained using a supervised-learning technique (e.g., a machine-learning technique or a neural network). The supervised-learning technique may include: a classification and regression tree, a support vector machine (SVM), linear regression, nonlinear regression, logistic regression, least absolute shrinkage and selection operator (LASSO), ridge regression, a random forest, and/or another type of supervised-learning technique. In some embodiments, the pre-trained machine-learning model may include a pre-trained neural network, such as a convolutional neural network or a recurrent neural network.

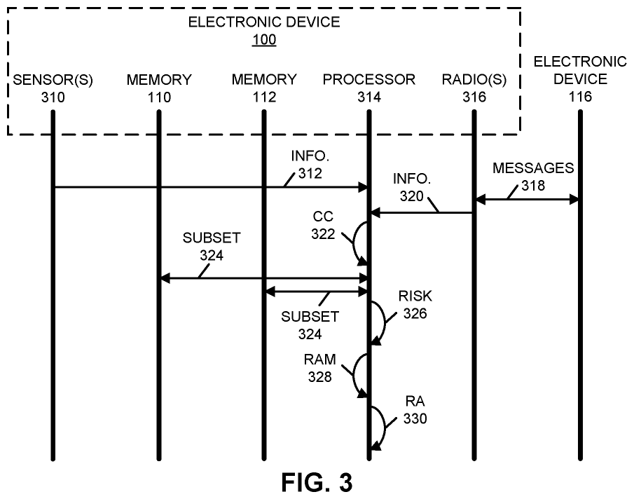

Embodiments of the communication techniques are further illustrated in FIG. 3, which presents a drawing illustrating an example of communication between components in electronic device 100 (FIG. 1). Notably, sensor(s) 310 in electronic device 100 may provide information 312 about a 3D position, speed, altitude and/or heading of electronic device 100 to processor 314 in electronic device 100.

Moreover, one or more radios 316 in electronic device 100 (such as a transponder and/or an interrogator) may receive messages 318 from electronic device 116. These messages may include information 320 about a 3D position, speed, altitude and/or heading of electronic device 116. Furthermore, the one or more radios 316 may provide information 320 to processor 314.

Then, processor 314 may determine current conditions (CC) 322 of electronic device 100, such as a position and speed of electronic device 100 (e.g., relative to electronic device 116). Moreover, processor 314 may access, in a first type of memory 110 in electronic device, a subset 324 of a collision avoidance and detection data structure based at least in part on current conditions 322, where subset 324 is less than a predefined size of the collision avoidance and detection data structure (such as 100 MB out of 2, 8 or 16 GB). Next, processor 314 may load subset 324 from the first type of memory 110 to a second type of memory 112 in electronic device 100.

Subsequently, when processor 314 determines that there is a potential risk 326 collision with electronic device 116, processor 314 may use subset 324 to compute a recommended avoidance maneuver (RAM) 328. Furthermore, processor 314 may perform a remedial action (RA) 330 based at least in part on the recommended avoidance maneuver 328, such as changing altitude, speed and/or heading.

While FIG. 3 illustrates communication between components using unidirectional or bidirectional communication with lines having single arrows or double arrows, in general the communication in a given operation in this figure may involve unidirectional or bidirectional communication. Moreover, while FIG. 3 illustrates operations being performed sequentially or at different times, in other embodiments at least some of these operations may, at least in part, be performed concurrently or in parallel.

We now discuss ACAS database (and, more generally, data structure) access. Traditional access to ACAS databases is to load them into memory and access them through indexed memory access similar to accessing items in an array. It is typically understood that the only way to achieve the performance required by ACAS is to load the databases into memory for high-speed access. However, this believe is incorrect. As illustrated in Table 1, in fact direct memory access is usually not required. This equals to maximum of about ((30+30+30)·20)=1,800 ACAS database access per second.

TABLE 1

| Parameter | Value |
|---|---|
| ACAS Update Frequency | 1 Hz |
| Maximum ATAR Intruders | 40 |
| Maximum ADS-B Intruders | 30 |
| Maximum DF0 Intruders | 30 |
| Database Access Per Intruder | Less than 20 |
| Average Record Size | 4 · Double = 4 · 32 = 200 bytes |

Empirically, the performance for non-buffered data access of 200-byte records was measured. Notably, for sequential access the performance was approximately 10,000 transactions/second, and for random access the performance was approximately 4,000 transactions/second. Note that these are conservative numbers and the actual performance would be higher, depending on the ACAS hardware design and components.

With both random and sequential access numbers well above the 1,800 database access per second, we confirm that, even without optimizations, loading ACAS databases into memory is not required.

Note that the reason sequential access is faster than random access is because how the data is typically stored in embedded Multimediacard (eMMC) memory and how it is retrieved. If the storage and retrieval data block sizes were the same as the record size, the non-buffered access times would be the same, but they are not. The eMMC data block size is 512 bytes. This is over twice the average ACAS record size, which means that a single eMMC data read retrieves 2.56 ACAS records. This is largely the difference between the empirical sequential and random-access transactions-per-second performance values.

However, ACAS database read optimizations are often used because most of the database reads are sequential. This means that it is usually optimal to read multiple 512 byte blocks at one time because it is likely that all the read blocks will be used before the next set of eMMC 512 byte blocks are read.

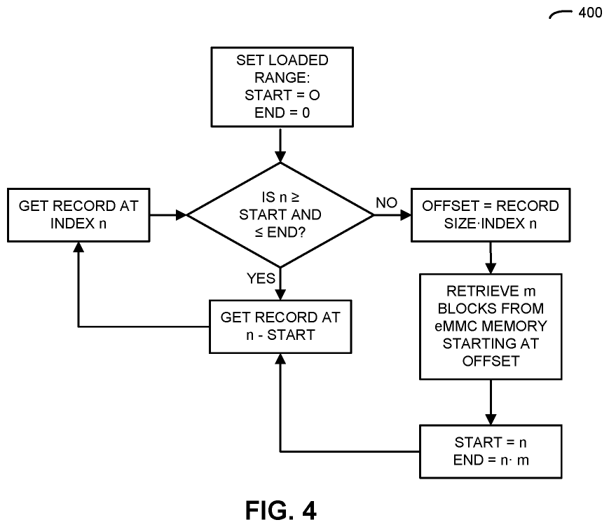

FIG. 4 presents a flow diagram illustrating an example of a method 400 for accessing a data record. This method shows an optimization technique that may be tuned for ACAS database access from memory, such as eMMC memory. In FIG. 4, method 400 may be tuned by varying the size of the value m until the optimal ACAS performance is achieved.

In some embodiments, methods 200 (FIG. 2) and/or 400 may include additional or fewer operations. Moreover, the order of the operations may be changed, there may be different operations, two or more operations may be combined into a single operation, and/or a single operation may be divided into two or more operations.

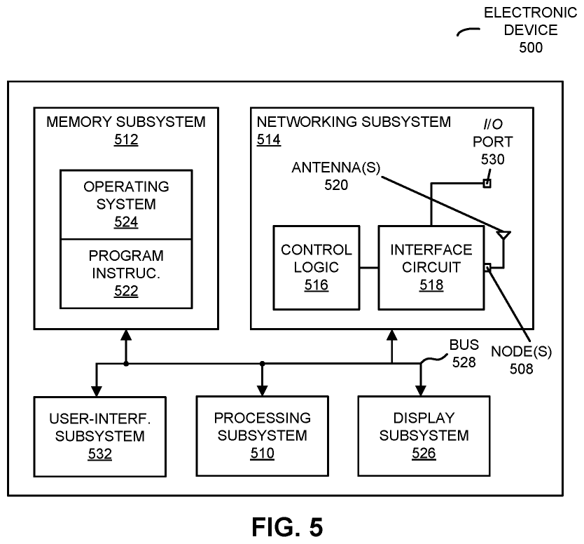

We now describe embodiments of an electronic device, which may perform at least some of the operations in the memory techniques, such as electronic device 100 (FIG. 1). FIG. 5 presents a block diagram illustrating an example of an electronic device 500, such as electronic device 100 (FIG. 1). This electronic device includes processing subsystem 510, memory subsystem 512, and networking subsystem 514. Processing subsystem 510 includes one or more devices configured to perform computational operations. For example, processing subsystem 510 can include one or more microprocessors, ASICs, microcontrollers, programmable-logic devices, one or more graphics process units (GPUs) and/or one or more DSPs.

Memory subsystem 512 includes one or more devices for storing data and/or instructions for processing subsystem 510 and networking subsystem 514. For example, memory subsystem 512 can include dynamic random access memory (DRAM), static random access memory (SRAM), and/or other types of memory. In some embodiments, instructions for processing subsystem 510 in memory subsystem 512 include: one or more program modules or sets of instructions (such as program instructions 522 or optional operating system 524), which may be executed by processing subsystem 510. Note that the one or more computer programs may constitute a computer-program mechanism. Moreover, instructions in the various modules in memory subsystem 512 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 510.

In addition, memory subsystem 512 can include mechanisms for controlling access to the memory. In some embodiments, memory subsystem 512 includes a memory hierarchy that comprises one or more caches coupled to a memory in electronic device 500. In some of these embodiments, one or more of the caches is located in processing subsystem 510.

In some embodiments, memory subsystem 512 is coupled to one or more high-capacity mass-storage devices (not shown). For example, memory subsystem 512 can be coupled to a magnetic or optical drive, a solid-state drive, or another type of mass-storage device. In these embodiments, memory subsystem 512 can be used by electronic device 500 as fast-access storage for often-used data, while the mass-storage device is used to store less frequently used data.

Networking subsystem 514 includes one or more devices configured to couple to and communicate using wired communication and/or wireless communication, including: control logic 516, an interface circuit 518 and one or more antennas 520 (or antenna elements) and/or input/output (I/O) port 530. (While FIG. 5 includes one or more antennas 520, in some embodiments electronic device 500 includes one or more nodes, such as nodes 508, e.g., a network node that can be coupled or connected to a network or link, or an antenna node or a pad that can be coupled to the one or more antennas 520. Thus, electronic device 500 may or may not include the one or more antennas 520.) For example, networking subsystem 514 can include or may be compatible with a variety of communication protocols, such as: a Bluetooth™ networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, a cable modem networking system, another networking system, a communication protocol associated with TCAS, a communication protocol associated with ACAS, a communication protocol associated with ADS-B or a communication protocol associated with another collision detection and avoidance system.

Networking subsystem 514 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 500 may use the mechanisms in networking subsystem 514 for performing simple wireless communication between the electronic devices, e.g., transmitting advertising or broadcast frames and/or scanning for advertising frames transmitted by other electronic devices.

Within electronic device 500, processing subsystem 510, memory subsystem 512, and networking subsystem 514 are coupled together using bus 528. Bus 528 may include an electrical, optical, and/or electro-optical connection that the subsystems can use to communicate commands and data among one another. Although only one bus 528 is shown for clarity, different embodiments can include a different number or configuration of electrical, optical, and/or electro-optical connections among the subsystems.

In some embodiments, electronic device 500 includes a display subsystem 526 (or is associated with a separate display subsystem 526) for displaying information on a display, which may include a display driver and the display, such as a liquid-crystal display, a multi-touch touchscreen, etc.

Electronic device 500 can be (or can be included in) any electronic device with at least one network interface. For example, electronic device 500 can be (or can be included in): a radio, a transponder, a transceiver, a type of aircraft, a computer, a computer system, a desktop computer, a laptop computer, a subnotebook/netbook, a tablet computer, a smartphone, a cellular telephone, a smartwatch, a consumer-electronic device, a portable computing device, communication equipment, a computer network device, test equipment, and/or another electronic device.

Although specific components are used to describe electronic device 500, in alternative embodiments, different components and/or subsystems may be present in electronic device 500. For example, electronic device 500 may include one or more additional processing subsystems, memory subsystems, networking subsystems, and/or display subsystems. Additionally, one or more of the subsystems may not be present in electronic device 500. Moreover, in some embodiments, electronic device 500 may include one or more additional subsystems that are not shown in FIG. 5, such as a user-interface subsystem 532. Also, although separate subsystems are shown in FIG. 5, in some embodiments some or all of a given subsystem or component can be integrated into one or more of the other subsystems or component(s) in electronic device 500. For example, in some embodiments program instructions 522 are included in optional operating system 524 and/or control logic 516 is included in interface circuit 518.

Moreover, the circuits and components in electronic device 500 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 514 (or, more generally, of electronic device 500). The integrated circuit may include hardware and/or software mechanisms that are used for transmitting wireless signals from electronic device 500 and receiving signals at electronic device 500 from other electronic devices. Aside from the mechanisms herein described, radios are generally known in the art and hence are not described in detail. In general, networking subsystem 514 and/or the integrated circuit can include any number of radios. Note that the radios in multiple-radio embodiments function in a similar way to the described single-radio embodiments.

In some embodiments, networking subsystem 514 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used particular communication protocols as an illustrative example, in other embodiments a wide variety of communication protocols and, more generally, wired and/or wireless communication techniques may be used. Thus, the memory techniques may be used with a variety of network or communication interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the memory techniques may be implemented using program instructions 522, optional operating system 524 (such as a driver for interface circuit 518) or in firmware in interface circuit 518. Alternatively or additionally, at least some of the operations in the memory techniques may be implemented in a physical layer, such as hardware in interface circuit 518.

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the memory techniques, different numerical values may be used.

Furthermore, note that the use of the phrases ‘capable of,’ capable to,′ ‘operable to,’ or ‘configured to’ in one or more embodiments, refers to some apparatus, logic, hardware, and/or element designed in such a way to enable use of the apparatus, logic, hardware, and/or element in a specified manner.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
a first type of memory storing a collision avoidance and detection data structure having a predefined size;
a second type of memory; and
a processor coupled to the first type of memory and the second type of memory, wherein the electronic device is configured to:
access a subset of the collision avoidance and detection data structure based at least in part on current conditions, wherein the subset is less than the predefined size, and the current conditions comprise a position and speed of the electronic device; and
load the subset from the first type of memory to the second type of memory.

2. The electronic device of claim 1, wherein the first type of memory comprises a non-volatile memory.

3. The electronic device of claim 1, wherein the second type of memory comprises a volatile memory.

4. The electronic device of claim 1, wherein the first type of memory comprises flash memory and the second type of memory comprises dynamic random access memory (DRAM).

5. The electronic device of claim 1, wherein the subset is loaded in less than a predefined time; and
wherein the predefined time is associated with a regulatory requirement.

6. The electronic device of claim 1, wherein the subset is loaded before it is needed or used.

7. The electronic device of claim 1, wherein accessing the subset comprises dynamically generating the subset.

8. The electronic device of claim 7, wherein the subset is dynamically adapted as a function of time.

9. The electronic device of claim 1, wherein the subset is predefined or predetermined.

10. The electronic device of claim 1, wherein the collision avoidance and detection data structure was previously subdivided into different subsets having associated indexing information.

11. The electronic device of claim 10, wherein at least two of the subsets, at least in part, partially overlap.

12. The electronic device of claim 1, wherein the subset is specified by a pretrained predictive model.

13. The electronic device of claim 1, wherein the current conditions comprise: an altitude of the electronic device, or a heading of the electronic device.

14. The electronic device of claim 1, wherein the position corresponds to a three-dimensional (3D) track of the electronic device, and the position is relative to a second electronic device.

15. A non-transitory computer-readable storage medium for use in conjunction with an electronic device, the computer-readable storage medium storing program instructions that, when executed by the electronic device, cause the electronic device to perform operations comprising:
accessing, in a first type of memory, a subset of a collision avoidance and detection data structure based at least in part on current conditions, wherein the subset is less than a predefined size of the collision avoidance and detection data structure, and the current conditions comprise a position and speed of the electronic device; and
loading the subset from the first type of memory to a second type of memory.

16. The non-transitory computer-readable storage medium of claim 15, wherein the first type of memory comprises a non-volatile memory and the second type of memory comprises a volatile memory.

17. The non-transitory computer-readable storage medium of claim 15, wherein accessing the subset comprises dynamically generating the subset.

18. A method for loading a subset of a collision avoidance and detection data structure, comprising:
by an electronic device:
accessing, in a first type of memory, the subset of the collision avoidance and detection data structure based at least in part on current conditions, wherein the subset is less than a predefined size of the collision avoidance and detection data structure, and the current conditions comprise a position and speed of the electronic device; and
loading the subset from the first type of memory to a second type of memory.

19. The method of claim 18, wherein the first type of memory comprises a non-volatile memory and the second type of memory comprises a volatile memory.

20. The method of claim 18, wherein accessing the subset comprises dynamically generating the subset.
